(19) United States
(12) Patent Application Publication
(10) Pub. No.: US 2024/0072304 A1
(43) Pub. Date: Feb. 29, 2024

(54) LITHIUM DIFLUOROPHOSPHATE, PREPARATION METHOD THEREFOR, AND APPLICATIONTHEREOF

(71) Applicant: SHENZHEN YANYI NEW MATERIALS CO., LTD., Shenzhen, Guangdong (CN)

(72) Inventors: Min YUE, Shenzhen, Guangdong (CN); Tianming FENG, Shenzhen, Guangdong (CN); Yi YU, Shenzhen, Guangdong (CN); Xianming WANG, Shenzhen, Guangdong (CN)

(21) Appl. No.: 18/290,285

(22) PCT Filed: Nov. 5, 2021
(86) PCT No.: PCT/CN2021/129085

§ 371 Date: Nov. 10, 2023

(30) Foreign Application Priority Data
May 20, 2021 (CN) 202110552376.3

(51) Int. Cl. H01M 10/0567; C01B 25/455

(52) U.S. Cl. CPC H01M 10/0567; C01B 25/455; C01P 2006/40; C01P 2006/82; H01M 2300/0025

(57) ABSTRACT

Lithium difluorophosphate, a preparation method therefor, and an application thereof. Lithium hexafluorophosphate and silicon tetrachloride are utilized to generate lithium difluorotetrachloro phosphate, then lithium difluorotetrachloro phosphate reacts with lithium carbonate to obtain a mixture of lithium difluorophosphate and lithium chloride, and then the mixture is purified to obtain high-purity lithium difluorophosphate. The method has simple steps, low cost, short reaction time, and a high conversion rate.

### TECHNICAL FIELD

The present invention relates to the technical field of lithium-ion batteries, and in particular to a preparation method for lithium difluorophosphate.

### BACKGROUND ART

As a new type of mobile portable power source, lithium-ion batteries have higher specific capacity and discharge voltage than traditional lead-acid batteries and alkaline batteries and have less environmental pollution. At present, the lithium-ion battery is mainly used as a portable mobile power supply and a mobile phone battery and is widely used in electric vehicles and automobiles as a power battery. Due to the strong support of national policy and the accumulation of lithium-ion battery technology in recent years, the lithium-ion battery industry has achieved tremendous development. However, the current lithium-ion battery has many drawbacks, and the conventional lithium hexafluorophosphate cannot satisfy the use of the lithium-ion battery under extreme conditions in the development of lithium salts. Lithium difluorophosphate can improve the high-temperature and low-temperature performance of lithium-ion batteries, which can significantly improve the cycle stability at −20° C., and can form a more stable SEI film at high temperatures, which can effectively prevent the electrolyte from corroding the electrode and current collector, thereby improving both high-temperature and low-temperature performance of lithium-ion batteries. In addition, lithium difluorophosphate has better stability than lithium hexafluorophosphate and is significantly more resistant to water and oxygen than lithium hexafluorophosphate. Therefore, as a new lithium salt additive, lithium difluorophosphate has great industrial value.

Many methods have been developed for the production of lithium difluorophosphate, which can be roughly divided into three routes: the lithium difluorophosphate route method, the lithium hexafluorophosphate route method, and other methods. However, the existing preparation methods and processes of lithium difluorophosphate are complex with high requirements for production equipment, numerous by-products and being difficult to generate solids, which is very unfavorable for the industrialization and promotion of lithium difluorophosphate.

In CN103052592 B, phosphorus pentafluoride, phosphorus acyl fluoride, and lithium phosphate were used to prepare a lithium difluorophosphate product. The technical route used involves using expensive, highly toxic, and highly dangerous phosphorus pentafluoride gas. The process is complicated, and the production equipment is strictly required, and the product cost is high.

In CN108147385 A, lithium hexafluorophosphate and water were used to prepare lithium difluorophosphate. Although halogenated siloxane can be decomposed, it is easy to decompose lithium hexafluorophosphate by this production method. At the same time, the reaction process is not easy to control, and there are many by-products, which is highly disadvantageous

CN101847753 A describes a preparation method for lithium difluorophosphate using lithium hexafluorophosphate and lithium carbonate in an aprotic solvent; however, the method has a long reaction time and a low conversion rate; at the same time, the method can only obtain a non-aqueous solution of lithium difluorophosphate, and cannot obtain lithium difluorophosphate with a high purity, which is very unfavorable for the promotion of lithium difluorophosphate; and in the salt solution, there are more or less some organic impurities and lithium fluoride, and these impurities may adversely affect the performance of a battery.

CN112591727 A discloses a preparation method for lithium difluorophosphate, wherein lithium hexafluorophosphate, oxalate, and silicon tetrachloride are reacted in an organic solvent; the reaction is carried out under a protective atmosphere. However, the yield of the method is low, especially the acid value is high, which will affect the performance of the electrolyte. In this method, an alkali solution is not used to neutralize the acidity, and lithium oxalate is basically not alkaline in organic solvents.

### SUMMARY OF THE INVENTION

In view of the defects existing in the prior art, the object of the present invention is to provide a preparation method for a lithium difluorophosphate solid, wherein the preparation process is simple, the cost is low, the reaction time is short, the conversion rate is high, the whole process is easy to control, water is not generated, and there is no by-product impurity after purification.

The present invention provides a preparation method for lithium difluorophosphate, comprising the following steps:
(1) stirring and reacting lithium hexafluorophosphate with silicon tetrachloride in a first non-aqueous solvent under substantially anhydrous conditions, and degassing and removing impurities to obtain a lithium difluorotetrachloro phosphate solution;
(2) dropwise adding the obtained lithium difluorotetrachloro phosphate solution into a lithium carbonate dispersion for reaction, and filtering to obtain a filter cake mixture of lithium difluorophosphate and lithium chloride;
(3) pulping the filter cake mixture with ethyl acetate, filtering to remove insoluble material, concentrating the pulping solution, and crystallizing by adding a non-polar solvent to obtain lithium difluorophosphate.

Preferably, the preparation method for lithium difluorophosphate according to the above is characterized in that the charge molar ratio of lithium hexafluorophosphate, silicon tetrachloride, and lithium carbonate is 1:(1-1.5):(2-2.5).

Preferably, the preparation method for lithium difluorophosphate according to the above is characterized in that in step (1), the molar concentration of lithium hexafluorophosphate is 1.5 to 4.0 mol/L, preferably 1.5 to 2.5 mol/L.

Preferably, the preparation method for lithium difluorophosphate according to the above is characterized in step (1), the reaction temperature of lithium hexafluorophosphate and silicon tetrachloride in the first non-aqueous solvent is 20 to 100° C., preferably 50 to 90° C., more preferably 70 to 90° C.

Preferably, the preparation method for lithium difluorophosphate according to the above is characterized in step (1), the gas used in degassing and removing impurities is a non-reactive gas, preferably one or two or more of nitrogen, argon, helium, and the like, and the temperature for degassing and removing impurities is 60 to 120° C., preferably 70 to 100° C., more preferably 85 to 100° C.

Preferably, the preparation method for lithium difluorophosphate according to the above is characterized in step (2), the reaction temperature of the lithium difluorotetrachloro phosphate and lithium carbonate is 30 to 80° C., preferably 50 to 80° C.

Preferably, the preparation method for lithium difluorophosphate according to the above is characterized in step (2), the lithium carbonate dispersion is prepared by mixing lithium carbonate with a second non-aqueous solvent, wherein the mass ratio of lithium carbonate to the second non-aqueous solvent is 1:(3-5), preferably 1:(4.2-5).

Preferably, the preparation method for lithium difluorophosphate according to the above is characterized in that the first non-aqueous solvent and the second non-aqueous solvent are each independently one or two or more of a cyclic carbonate, a chain carbonate, and a cyclic ether, preferably one or two or more of dimethyl carbonate, methyl ethyl carbonate, diethyl carbonate, ethylene carbonate, 1,4-dioxane, tetrahydrofuran.

Preferably, the preparation method for lithium difluorophosphate according to the above is characterized in that in step (3), the mass ratio of the filter cake mixture to ethyl acetate is 1:(1-2), preferably 1:(1.90-2), the filter cake mixture being pulped with ethyl acetate for 3 to 5 h.

Preferably, the preparation method for lithium difluorophosphate according to the above is characterized in step (3), concentrating pulping solution is carried out by subjecting the filtrate to vacuum distillation at a temperature of 40 to 80° C., preferably 45 to 65° C., more preferably 50 to 65° C.

Preferably, the preparation method for lithium difluorophosphate according to the above is characterized in step (3), the non-polar solvent is one or two or more of n-hexane, n-pentane, cyclohexane, heptane, dichloromethane, trichloromethane, 1,2-dichloroethane.

Preferably, the preparation method for lithium difluorophosphate according to the above is characterized in that in step (3), the temperature for crystallization is 0 to 5° C., preferably 0 to 3.5° C.

Preferably, the preparation method for lithium difluorophosphate according to the above is characterized in that in step (3), after crystallization, filtration is also performed to obtain a filter cake, and the filter cake is dried to obtain lithium difluorophosphate at a temperature of 80 to 120° C., preferably 100 to 120° C.

Preferably, the preparation method for lithium difluorophosphate according to the above is characterized in that in both step (1) and step (2), the reaction is carried out in an atmosphere of an inert gas, the inert gas being one or two or more of nitrogen, argon, and helium.

The present invention further provides a lithium difluorophosphate prepared by the preparation method of any one of claims 1 to 14, which is characterized in that the lithium difluorophosphate has a purity of ≥99.8% and a free acid content of ≤50 ppm, preferably ≤25 ppm.

Preferably, the lithium difluorophosphate according to the above is characterized by a moisture content of ≤10 ppm, a Cl⁻ content of ≤1 ppm, preferably ≤0.8 ppm, the sum of the content of impurity metal ions of ≤2 ppm, preferably ≤1.5 ppm.

The present invention also provides a non-aqueous electrolyte battery comprising a positive electrode, a negative electrode, and an electrolyte comprising the lithium difluorophosphate described above.

Use of the lithium difluorophosphate described above in the preparation of a non-aqueous electrolyte battery.

The present invention has the following advantages and effects with respect to the prior art:

The preparation method for a lithium difluorophosphate solid provided by the present invention uses a two-step reaction, the process is simple, and the raw materials use commonly used lithium hexafluorophosphate, silicon tetrachloride, and lithium carbonate, which are all common cheap bulk chemicals and have low preparation costs. In the first step, the intermediate LiPF₂Cl₄ is formed, which has four chlorine atoms. The radius of the chlorine atom is large, and the binding force with the phosphorus element is less than that with the fluorine atom. The chlorine atom is easier to leave, so it is easier to form lithium difluorophosphate, the reaction rate is faster and the reaction time is shorter. In addition, there is no water involved in the whole reaction process, which avoids the production of impurities by hydrolysis of the product, resulting in the problem of low purity. In the present invention, lithium carbonate is used as a starting material for the reaction, which is inexpensive, widely available, and in slight excess, and is usually used alone for acid removal in an organic solvent, thereby neutralizing the free acid and reducing the acid value in the present invention.

### DETAILED DESCRIPTION OF THE INVENTION

In order to better understand the above-mentioned technical solutions, the technical solutions of the present application are described in detail through specific examples below, and it should be understood that the examples and the specific features in the examples of the present application are a detailed description of the technical solutions of the present application rather than a limitation of the technical solutions of the present application, and the examples and the technical features in the examples of the present application can be combined with each other without conflict.

The preparation method for lithium difluorophosphate provided by the present invention is a two-step reaction method, and the corresponding chemical reaction formula thereof is as follows:

LiPF₆+SiCl₄→LiPF₂Cl₄+SiF₄↑

LiPF₂Cl₄+2Li₂CO₃→LiPO₂F₂+2CO₂↑+4LiCl

In particular, in a preferred example, the specific steps of the preparation method for the present invention are as follows:

(1) In the case of being substantially anhydrous, lithium hexafluorophosphate is reacted with silicon tetrachloride under the protection of an inert gas to prepare a lithium difluorotetrachloro phosphate solution. After the completion of the reaction in this step, it is necessary to degas and remove impurities, so as to remove silicon tetrafluoride and prevent the residual silicon tetrafluoride from affecting the next reaction.

(2) A mixture of lithium difluorophosphate and lithium chloride can be obtained by dropping the prepared lithium difluorotetrachloro phosphate solution into a lithium carbonate dispersion for reaction.

(3) The filter cake was pulped with ethyl acetate, and filtered, and the pulping solution was collected and concentrated. A non-aqueous solvent was aqueous solvent to obtain a filter cake, which was dried to obtain lithium difluorophosphate.

In step (1), the reaction is carried out in a first non-aqueous solvent. The first non-aqueous solvent is one or a combination of two or more selected from the group consisting of a cyclic carbonate, a chain carbonate, a cyclic ester, a chain ester, and a cyclic ether, preferably one or a combination of two or more selected from the group consisting of dimethyl carbonate, methyl ethyl carbonate, diethyl carbonate, ethylene carbonate, 1,4-dioxane, tetrahydrofuran, more preferably dimethyl carbonate, methyl ethyl carbonate, or diethyl carbonate. The molar ratio of lithium hexafluorophosphate to silicon tetrachloride was 1:(1-1.5), excess silicon tetrachloride is allowed to ensure the complete reaction of lithium hexafluorophosphate if the molar ratio is less than 1:1, a large amount of lithium hexafluorophosphate will remain in the reaction solution; if higher than 1:1.5, a large amount of silicon tetrachloride remains and subsequent removal is costly. The concentration of lithium hexafluorophosphate is 1.5 to 4.0 mol/L, and when the concentration is less than 1.5 mol/L, it affects the reaction rate. When the concentration is higher than 4.0 mol/L, the solution is liable to change color and has an effect on the final product. The reaction temperature is 20 to 100° C., preferably 50 to 90° C., further preferably 70 to 90° C. When the reaction temperature is too low, the reaction rate is low. When the temperature is too high, the decomposition of lithium hexafluorophosphate is accelerated, and by-product impurities are easily produced. The temperature for degassing and removing impurities is 60 to 120° C., preferably 70 to 100° C., more preferably 85 to 100° C. When the degassing temperature is lower than 60° C., the concentration of chlorine compounds in the reaction solution is high and it cannot be used as an additive for the non-aqueous electrolyte. When degassing temperatures are higher than 120° C., it can cause boiling of the solution and loss of material. The gas used for degassing and removing impurities is a non-reactive gas, preferably one or a combination of two or more selected from the group consisting of nitrogen, argon, helium, and the like.

In step (2), the reaction is carried out under an inert atmosphere. The lithium carbonate dispersion is prepared from lithium carbonate and a second non-aqueous solvent, wherein the mass ratio of lithium carbonate to the second non-aqueous solvent is 1:(3 to 5), preferably 1:(4.2-5) if the mass ratio is less than 1:3, a normal lithium carbonate slurry-like uniform dispersion cannot be formed, which may result in insufficient reaction. If the mass ratio is more than 1:5, the solvent is wasted. The second non-aqueous solvent is one or a combination of two or more selected from the group consisting of cyclic carbonate, chain carbonates, cyclic esters, chain esters, and cyclic ethers, preferably one or a mixture of two or more of dimethyl carbonate, methyl ethyl carbonate, diethyl carbonate, ethylene carbonate, 1,4-dioxane, tetrahydrofuran, more preferably dimethyl carbonate, methyl ethyl carbonate, and diethyl carbonate. The molar ratio of lithium hexafluorophosphate to lithium carbonate was 1:(2-2.5), this limit value is to ensure the complete reaction of lithium difluorotetrachloro phosphate, the lithium carbonate is wasted when the value is higher than 1:2.5; the reaction does not proceed to completion when it is less than 1:2. The reaction temperature is 20 to 80° C., preferably 30 to 80° C., and when the temperature is lower than 20° C., the reaction rate is too slow; when the temperature is too high, side reactions are easily generated to generate PO₃⁻ and PO₄³⁻.

In steps (1) and (2), the inert gas is one or two or more of nitrogen, argon, and helium.

In step (3), the weight of ethyl acetate is 1 to 2 times, preferably 1.90 to 2 times, and the weight of the filter cake mixture. If it is less than 1 time, it is easy to cause incomplete extraction of the product, resulting in reduced yield. If it is higher than 2 times, it results in waste of solvent. The pulping time was 3 to 5 h, so that the lithium difluorophosphate be fully dissolved into the ethyl acetate solution. The pulping solution is collected and concentrated by subjecting the filtrate to vacuum distillation, wherein the temperature of the vacuum distillation is 40 to 80° C., preferably 45 to 65° C., more preferably 50 to 65° C., and when the temperature is lower than 40° C., the distillation speed is slow; when it is higher than 80° C., lithium difluorophosphate may become entrained in the solvent, causing some loss in yield.

The crystallization solvent is a weak polar or non-polar solvent, and is preferably one or a combination of two or more selected from the group consisting of n-hexane, n-pentane, cyclohexane, heptane, dichloromethane, trichloromethane, and 1,2-dichloroethane. The crystallization temperature is 0 to 5° C., and the crystallization time is 2 to 5 h. The filter cake is dried at a temperature of 80 to 120° C., preferably 100 to 120° C., for a period of 8 to 15 h, preferably 12 to 15 h. They are not particularly limited as long as the desired crystallization effect can be achieved.

Lithium difluorophosphate prepared by the method of the present invention, wherein purity ≥99.8%, free acid content ≤50 ppm, moisture content ≤10 ppm, Cl⁻ content ≤1 ppm, preferably ≤0.8 ppm, the sum of impurity metal ion content ≤2 ppm, preferably ≤1.5 ppm.

### EXAMPLES

The raw materials or reagents used in the present invention are commercially available from mainstream manufacturers, manufacturers not specified, or concentrations not specified, and are analytically pure raw materials or reagents that can be conventionally obtained, provided that they can perform the intended function, without particular limitation. The instruments and equipment used in this example are all purchased from major commercial manufacturers and are not particularly limited as long as they can perform the intended functions. Where no specific techniques or conditions are specified in the examples, they are performed according to the techniques or conditions described in the literature in the field or according to the product description.

Raw materials and instruments:
Glove box available from MIKOUNA, model Siemens S7;
Vacuum drying oven, purchased from Shanghai Yiheng, model: DZF-6050;
Ion chromatography, using Metrohm 833 ion chromatograph;
Inductively coupled plasma emission spectrometer (ICP-OES), Jitian Instruments ICP-5000 inductively coupled plasma emission spectrometer;
Karl Fischer test uses Jintai SF-3 Karl Fischer moisture tester for moisture test;
dimethyl carbonate, methyl ethyl carbonate, diethyl carbonate, ethyl acetate, and silicon tetrachloride were purchased from the Aladdin reagent website;
lithium hexafluorophosphate purchased from Morita New Energy Materials (Zhangjiagang); lithium carbonate, purchased from Ganfeng Lithium Group.

### Example 1

(1) In a glove box having a moisture content of less than 10 mass ppm, a 250 ml three-necked flask was prepared, 150 ml of dimethyl carbonate having a moisture content of less than 10 mass ppm was added to the flask, and the three-necked flask was placed in a refrigerator of the glove box for freezing, and then 45.0 g of lithium hexafluorophosphate (0.296 mol, molecular weight 151.9 g/mol) was weighed so that the molar concentration of lithium hexafluorophosphate was 1.97 mol/L. It was slowly dissolved in the frozen dimethyl carbonate solvent, and the temperature of the solution was controlled at 5 to 10° C. during the dissolution process. After the operation, the above three-necked flask was transferred to the outside of the glove box and placed in an oil bath kettle at normal temperature. 50.29 g of silicon tetrachloride (0.296 mol, the molecular weight of silicon tetrachloride 169.9 g/mol) was weighed and quickly added into a constant pressure dropping funnel, then a condensation tube and a constant pressure dropping funnel were fitted, and the system was protected with nitrogen. Then, the temperature of the oil bath was slowly raised to 50° C. while silicon tetrachloride was slowly added dropwise to the three-necked flask for reaction, and the tail gas was introduced into an aqueous sodium hydroxide solution through a conduit for absorption. When no more bubbles emerge from the tail suction port, the reaction is continued for another 2 to 3 h, and the reaction is completed. At this time, the temperature of the reaction solution was raised to 80° C., a bubbler was inserted into the three-necked flask and slowly bubbled with nitrogen, and the bubbled gas was absorbed with aqueous sodium hydroxide solution until the wet pH paper was neutral after contacting the bubbled gas, indicating that the residual silicon tetrachloride and silicon tetrafluoride gases had been completely discharged. At this time, the LiPF₂Cl₄ solution from the first reaction was cooled to room temperature and quickly introduced into a constant pressure dropping funnel and sealed for later use.

(2) Another 500 ml three-necked flask was taken for adding 140 ml of dimethyl carbonate solvent with moisture content of less than 10 mass ppm, which was placed in an oil bath kettle for stirring at room temperature, 45.8 g (0.62 mol, the molecular weight of lithium carbonate is 73.9 g/mol) of lithium carbonate was weighed, quickly added into the three-necked flask for stirring until uniform to form a dimethyl carbonate slurry containing lithium carbonate. A constant pressure dropping funnel containing LiPF₂Cl₄ solution obtained in the previous step (1) and a condensation tube is loaded onto the three-necked flask in step (2), protected by nitrogen, LiPF₂Cl₄ solution was slowly added dropwise at 30° C., the generated carbon dioxide gas was introduced into a tail gas absorption bottle and absorbed with aqueous sodium hydroxide solution, and the reaction is completed until no bubble emerges in the tail gas absorption bottle. Cooled to room temperature and quickly filtered to give 118 g of a wet solid mixture (filter cake mixture) which was transferred to a flask.

(3) 160 ml (144.32 g) of Ethyl acetate was added to the filter cake mixture obtained in step (2), which was pulped at room temperature, after pulping for 3.5 h, filtering, the pulping solution was collected, vacuum distillation was performed at 50° C. until just saturated, the vacuum distillation stops and was cooled to about 0° C. Dichloromethane was added for stirring and crystallization, the crystallization time was 3 h, a pure white powder filter cake was obtained after filtration, and the same was placed in a vacuum drying oven, and dried at 120° C. for 10 h, to obtain a pure white powder solid lithium difluorophosphate of 29.5 g, with a yield of 93.2%.

The high-purity lithium difluorophosphate is a high-purity white powdery solid, and the purity thereof is ≥99.9% as determined by ion chromatography, the free acid is 20 ppm as determined by titration, the moisture content is ≤10 ppm as determined by Karl Fischer method, the Cl⁻ content is 0.3 ppm as determined by titration, and the sum of the contents of impurity metal ions is 0.5 ppm as determined by ICP-OES method. See Table 3 for details.

### Examples 2 to 6

The same as in Example 1 except that various materials and amounts thereof, condition parameters, and the like were selected according to Tables 1 and 2.

### Comparative Example 1

Lithium difluorophosphate is prepared according to the technical route “lithium hexafluorophosphate+lithium carbonate+anhydrous anaerobic state→lithium difluorophosphate” disclosed in CN107381531 A.

In a 1 L vessel, 600 ml of diethyl carbonate (DEC) was added, 1.0 mol of lithium carbonate was added, the temperature was raised to 62° C., then 0.5 mol of lithium hexafluorophosphate was slowly added, the temperature was controlled at 68° C. after the addition was completed, the temperature was raised to 73° C., and the mixture was stirred for 2 h; the obtained reaction solution was filtered. After filtration, 102 g of a wet solid of a filter cake was obtained; 153 g of ethyl acetate was added for pulping for 5 h, and then the insoluble filter residue was filtered off; the obtained filtrate was vacuum distilled at 60° C. to just saturated, placed in a 0° C. ice bath, and a poor solvent, dichloromethane, was added for stirring and crystallization; the crystallization time was 4 h, and the obtained lithium difluorophosphate product was dried in a vacuum drying oven at 120° C. for 10 h to obtain 39.42 g of lithium difluorophosphate solid with a yield of 73.0%. See Table 3 for relevant parameter tests.

### Comparative Example 2

According to the technical route “lithium hexafluorophosphate+lithium carbonate+ultrapure water→lithium difluorophosphate” disclosed in CN108128764 A, lithium difluorophosphate is prepared.

152 g (1.0 mol) of lithium hexafluorophosphate was dissolved into 1000 ml of dimethyl carbonate, 0.5 g of ultrapure water was added, the temperature was raised to 80° C., then 148 g (2.0 mol) of lithium carbonate was added, the reaction was stirred for 1.5 h. After filtration, 235 g of a wet solid of a filter cake was obtained; 329 g of ethyl acetate was added for pulping for 5 h, and then the insoluble filter residue was filtered off; the obtained filtrate was vacuum distilled at 60° C. to just saturated, placed in a 0° C. ice bath, and a poor solvent, dichloromethane, was added for stirring and crystallization; the crystallization time was 5 h, and the obtained lithium difluorophosphate product was dried in a vacuum drying oven at 120° C. for 12 h to obtain 98.5 g of lithium difluorophosphate solid with a yield of 92.1%. See Table 3 for relevant parameter tests.

### Comparative Example 3

Lithium difluorophosphate is prepared according to the methods disclosed in JP6226643 B2 “lithium hexafluorophosphate+chloride+water (without solvent)→lithium difluorophosphate” and KR102218938 B1 “lithium hexafluorophosphate+chloride (lithium chloride, silicon tetrachloride, etc.)+water vapor (oxygen element provided by water)→lithium difluorophosphate”.

152 g (1.0 mol) of LiPF₆ and 258.1 g (2.0 mol) of dimethyldichlorosilane were dissolved in 505 g of methyl ethyl carbonate and cooled to 0° C. After slowly adding dropwise 36 g (2 mol) of water, the mixture was warmed to 25° C., stirred for 3 h, then warmed to 30° C., pre-degassed under reduced pressure, then formally degassed at 30° C. under an absolute pressure of 30 Pa, and the resulting slurry was filtered to obtain 217 g of a wet filter cake. 325.5 g of ethyl acetate was added for pulping for 4 h, and then the insoluble filter residue was filtered off; the obtained filtrate was vacuum distilled at 60° C. to just saturated, placed in a 0° C. ice bath, and a poor solvent, dichloromethane, was added for stirring and crystallization; the crystallization time was 4 h, and the obtained lithium difluorophosphate product was dried in a vacuum drying oven at 120° C. for 10 h to obtain 94.7 g of lithium difluorophosphate solid with a yield of 87.7%. See Table 3 for relevant parameter tests.

TABLE 1

| | Step 1 | | | | | | |
|---|---|---|---|---|---|---|---|
| | | | | Molar | Molar | | Temperature |
| | First | LiPF₆ | LiPF₆ | weight | ratio of | Reaction | for degassing |
| | non- | molar | concent | of silicon | LiPF₆ | temperature | and removing |
| | aqueous | weight | ration | tetrachloride | to | in Step 1 | impurities |
| | solvent | [mol] | [mol/L] | [mol] | SiCl₄ | [° C.] | [° C.] |
| Example 1 | DMC | 0.296 | 1.97 | 0.296 | 1:1.00 | 50 | 80 |
| Example 2 | DMC | 0.296 | 2.5 | 0.444 | 1:1.50 | 80 | 100 |
| Example 3 | DEC | 0.296 | 1.5 | 0.385 | 1:1.30 | 60 | 100 |
| Example 4 | EMC | 0.296 | 2.0 | 0.355 | 1:1.20 | 90 | 90 |
| Example 5 | DMC | 0.350 | 1.8 | 0.490 | 1:1.40 | 30 | 70 |
| Example 6 | DMC | 0.400 | 2.2 | 0.520 | 1:1.30 | 70 | 85 |
| Comparative | DEC | 0.5 | 0.83 | — | — | 73 | — |
| Example 1 | | | | | | | |
| Comparative | DMC | 1.0 | 1.0 | — | — | 80 | — |
| Example 2 | | | | | | | |
| Comparative | EMC | 1.0 | 2.0 | Dimethyl | | | |
| Example 3 | | | | dichloro- | | | |
| | | | | silane | | | |
| | | | | 2.0 mol | | | |

| | Step 2 | | | | | |
|---|---|---|---|---|---|---|
| | Molar | | | Type and | Mass | |
| | weight | Molar | | addition | ratio of | |
| | and | ratio of | | amount of | lithium | |
| | mass of | LiPF₆ | | second | carbonate | Filter |
| | lithium | to | Reaction | non-aqueous | to second | cake |
| | carbonate | lithium | temperature | solvent | non-aqueous | mixture |
| | added | carbonate | [° C.] | [g] | solvent | [g] |
| Example 1 | 0.62 mol | 1:2.09 | 30 | DMC | 1:3.0 | 112 |
| | (45.82 g) | | | 137.46 | | |
| Example 2 | 0.74 mol | 1:2.50 | 50 | DMC | 1:5.0 | 125 |
| | (54.69 g) | | | 273.45 | | |
| Example 3 | 0.65 mol | 1:2.20 | 60 | DEC | 1:4.0 | 115 |
| | (48.04 g) | | | 192.40 | | |
| Example 4 | 0.65 mol | 1:2.20 | 80 | EMC | 1:4.2 | 120 |
| | (48.04 g) | | | 201.77 | | |
| Example 5 | 0.74 mol | 1:2.11 | 50 | DMC | 1:4.0 | 125 |
| | (54.69 g) | | | 219.04 | | |
| Example 6 | 0.85 mol | 1:2.13 | 70 | DMC | 1:4.8 | 136 |
| | (62.82 g) | | | 303.40 | | |
| Comparative | 1.0 mol | 1:2.00 | — | — | — | 102 |
| Example 1 | | | | | | |
| Comparative | 2.0 mol | 1:2.00 | — | — | — | 235 |
| Example 2 | | | | | | |
| Comparative | | | | | | 217 |
| Example 3 | | | | | | |

Note:
DMC is dimethyl carbonate; DEC is diethyl carbonate; EMC is methyl ethyl carbonate

TABLE 2

| | Step (3) | | | | | | | | |
|---|---|---|---|---|---|---|---|---|---|
| | | Mass ratio | | | | | | | |
| | Amount | of filter | | | | | | | |
| | of ethyl | cake | | Temperature | | | | | |
| | acetate | mixture | Pulping | for vacuum | Crystallization | Crystallization | Drying | Drying | |
| | added | to ethyl | time | distillation | temperature | duration | temperature | duration | Yield |
| | [g] | acetate | [h] | [° C.] | [° C.] | [h] | [° C.] | [h] | [%] |
| Example 1 | 144.32 | 1:1.29 | 3.5 | 50 | 0 | 3 | 120 | 10 | 93.2 |
| Example 2 | 237.50 | 1:1.90 | 5.0 | 50 | 2 | 5 | 110 | 12 | 95.0 |
| Example 3 | 172.50 | 1:1.50 | 4.0 | 60 | 5 | 3 | 90 | 15 | 92.0 |
| Example 4 | 240.00 | 1:2.00 | 4.0 | 60 | 3.5 | 4 | 120 | 12 | 94.5 |
| Example 5 | 125.00 | 1:1.00 | 3.0 | 45 | 2 | 5 | 80 | 8 | 90.8 |
| Example 6 | 258.40 | 1:1.90 | 3.5 | 65 | 0 | 3 | 100 | 15 | 94.1 |
| Comparative | 153.00 | 1:1.5 | 5 | 60 | 0 | 4 | 120 | 10 | 73.0 |
| Example 1 | | | | | | | | | |
| Comparative | 329.00 | 1:1.4 | 5 | 60 | 0 | 5 | 120 | 12 | 92.1 |
| Example 2 | | | | | | | | | |
| Comparative | 325.50 | 1:1.5 | 4 | 60 | 0 | 4 | 120 | 10 | 87.7 |
| Example 3 | | | | | | | | | |

TABLE 3

| | | | | | Impurity |
|---|---|---|---|---|---|
| | | Free | | Chloride | metal |
| | Purity | acid | Moisture | ion content | ion content |
| | [%] | [ppm] | [ppm] | [ppm] | [ppm] |
| Example 1 | 99.8 | 21 | <10 | 0.5 | 1.5 |
| Example 2 | 99.9 | 19 | <10 | 0.2 | 1.0 |
| Example 3 | 99.9 | 23 | <10 | 0.8 | 1.3 |
| Example 4 | 99.9 | 21 | <10 | 0.2 | 0.8 |
| Example 5 | 99.9 | 25 | <10 | 0.6 | 1.2 |
| Example 6 | 99.9 | 18 | <10 | 0.3 | 0.7 |
| Comparative | 99.1 | 75 | <10 | — | 2.3 |
| Example 1 | | | | | |
| Comparative | 99.1 | 158 | 106 | — | 3.1 |
| Example 2 | | | | | |
| Comparative | 99.4 | 238 | 128 | 35 | 1.8 |
| Example 3 | | | | | |

As shown in Table 3, analyzing the test results of Examples 1 to 6 and Comparative Examples 1, 2, and 3, it can be seen that in Examples 1 to 6, compared to Comparative Examples 1, 2, and 3, there are excellent effects in terms of yield and great advantages in terms of product purity, and the reaction system of the present invention does not contain water and does not produce water, and thus has absolute advantages in terms of product purity and water content.

It can be seen from the test results that Examples 2, 4, and 6 have better effects in terms of purity and yield, indicating that the addition of a relatively large amount of pulping solvent is advantageous and preferred.

In summary, in the present invention, lithium hexafluorophosphate with silicon tetrachloride to prepare an intermediate, and then using the intermediate reacts with lithium carbonate to produce lithium difluorophosphate, wherein the intermediate can react more thoroughly with lithium carbonate, which directly shows that the product purity and yield are higher than those in the comparative example; in addition, the present invention can reduce the content of chloride ions to less than 1 ppm by dechlorinating and removing impurities; in the reaction system of the present invention, no water is contained, no water is produced, and the moisture content of the resulting product can all be reduced to less than 10 ppm, thus meeting the practical requirements for lithium battery applications.

While the foregoing is directed to examples of the present invention, other and further examples of the invention may be devised without departing from the basic scope thereof, and the scope thereof is determined by the claims that follow. Those skilled in the art to which the invention relates will readily appreciate that many modifications, additions, and substitutions are possible, without departing from the scope and spirit of the invention as disclosed in the accompanying claims. Such derivations, variations, or alternatives are intended to fall within the scope of the appended claims.

1. A preparation method for lithium difluorophosphate, comprising the following steps of:
(1) stirring and reacting lithium hexafluorophosphate with silicon tetrachloride in a first non-aqueous solvent under substantially anhydrous conditions, and degassing and removing impurities to obtain a lithium difluorotetrachloro phosphate solution;
(2) dropwise adding the obtained lithium difluorotetrachloro phosphate solution into a lithium carbonate dispersion for reaction, and filtering to obtain a filter cake mixture of lithium difluorophosphate and lithium chloride; and
(3) pulping the filter cake mixture with ethyl acetate, filtering to remove insoluble material, concentrating the pulping solution, and crystallizing by adding a non-polar solvent to obtain lithium difluorophosphate.

2. The preparation method for lithium difluorophosphate according to claim 1, characterized in that the charge molar ratio of lithium hexafluorophosphate, silicon tetrachloride, and lithium carbonate is 1:(1-1.5):(2-2.5).

3. The preparation method for lithium difluorophosphate according to claim 1, characterized in that in step (1), the molar concentration of lithium hexafluorophosphate is 1.5 to 4.0 mol/L.

4. The preparation method for lithium difluorophosphate according to claim 1, characterized in that
in step (1), reaction temperature of lithium hexafluorophosphate and silicon tetrachloride in the first non-aqueous solvent is 20° C. to 100° C.

5. The preparation method for lithium difluorophosphate according to claim 1, characterized in that
in step (2), the reaction temperature of lithium difluorotetrachloro phosphate and lithium carbonate is 30° C. to 80° C.

6. The preparation method for lithium difluorophosphate according to claim 1, characterized in that the first non-aqueous solvent and the second non-aqueous solvent are each independently one or a combination of two or more selected from the group consisting of a cyclic carbonate, a chain carbonate, and a cyclic ether.

7. The preparation method for lithium difluorophosphate according to claim 1, characterized in that in step (3), the mass ratio of the filter cake mixture to ethyl acetate is 1:(1-2), the filter cake mixture being pulped with ethyl acetate for 3 to 5 h.

8. The preparation method for lithium difluorophosphate according to claim 1, characterized in that
in step (3), the non-polar solvent is one or a combination of two or more selected from the group consisting of n-hexane, n-pentane, cyclohexane, heptane, dichloromethane, trichloromethane, and 1,2-dichloroethane.

9. The preparation method for lithium difluorophosphate according to claim 1, characterized in that in step (3), the temperature for crystallization is 0° C. to 5° C.

10. The preparation method for lithium difluorophosphate according to claim 1, characterized in that in step (3), after crystallization, filtration is also performed to obtain a filter cake, and the filter cake is dried to obtain lithium difluorophosphate at a temperature of 80° C. to 120° C.

11. The preparation method for lithium difluorophosphate according to claim 1, characterized in that in both step (1) and step (2), the reaction is carried out in an atmosphere of inert gas, wherein the inert gas is one or more gases selected from the group consisting of nitrogen, argon, and helium.

12. A lithium difluorophosphate prepared by the preparation method according to claim 1, characterized in that the lithium difluorophosphate has a purity of ≥99.8% and a free acid content of ≤50 ppm.

13. The lithium difluorophosphate according to claim 12, characterized by having a moisture content of ≤10 ppm, a Cl⁻ content of ≤1 ppm, the sum of the content of impurity metal ions of ≤2 ppm.

14. A non-aqueous electrolyte battery characterized by comprising a positive electrode, a negative electrode, and an electrolyte comprising the lithium difluorophosphate of claim 12.

15. (canceled)

16. The preparation method for lithium difluorophosphate according to claim 1, characterized in that in step (1), the gas used in the degassing and removing impurities is a non-reactive gas, and the temperature of the degassing and impurity removal is 60° C. to 120° C.

17. The preparation method for lithium difluorophosphate according to claim 16, characterized in that the non-reactive gas is one or more gases selected from the group consisting of nitrogen, argon, helium, and combination thereof.

18. The preparation method for lithium difluorophosphate according to claim 1, characterized in that in step (2), preparing a lithium carbonate dispersion by mixing lithium carbonate with a second non-aqueous solvent, wherein the mass ratio of lithium carbonate to the second non-aqueous solvent is between 1:3 and 1:5.

19. The preparation method for lithium difluorophosphate according to claim 1, characterized in that in step (3), the concentrating pulping solution is carried out by subjecting the filtrate to vacuum distillation at a temperature of 40° C. to 80° C.

20. The lithium difluorophosphate according to claim 12, wherein the lithium difluorophosphate has a free acid content of ≤25 ppm.

21. The lithium difluorophosphate according to claim 13, characterized by having a Cl⁻ content of ≤0.8 ppm, the sum of the content of impurity metal ions of ≤1.5 ppm.
